(19) United States
(12) Patent Application Publication
(10) Pub. No.: US 2004/0055191 A1
(43) Pub. Date: Mar. 25, 2004

(54) Temporary sign support

(76) Inventor: Terry Kresser, Ft. Myers, FL (US)

Correspondence Address: Terry Kresser, 13307 Broadhurst Loop, Fort Myers, FL, 33919, US

(21) Appl. No.: 10/246,879

(22) Filed: Sep. 19, 2002

(51) Int. Cl. G09F 13/00

(52) U.S. Cl. 40/560

(57) ABSTRACT

The invention involves a temporary sign that is installed in front of a residence to alert persons who deliver items or are called for to deliver a service. This includes emergency services. It is well known fact that to locate residences by their house numbers can at times be very difficult. This is especially true when the person making the call is not familiar with the neighborhood. This is even more difficult if the call has to be made in the dark when house numbers cannot be seen at all unless they are illuminated which is seldom the case. For this purpose, the temporary sign can be installed in front of the residence. The sign can have changeable messages that are directed to the service to be rendered. The sign can be illuminated or can have blinking lights thereon. The sign could be hung on a porch or a front entrance way or could be placed in a window.

### CROSS REFERENCE TO RELATED APPLICATIONS

(none)

### STATEMENT REGARDING FED SPONSORED R & D

(none)

### BACKGROUND OF THE INVENTION

The invention is directed to temporary signs that may placed in front of a residence including single homes, apartments and condominiums to direct persons on delivery of items that have been ordered or orders or calls in an emergency ect. It is well known fact that house numbers on individual houses or on buildings can frequently not be seen because of their placement or are obscured by bushes or tree branches. In the dark it is almost impossible to find the destination where a delivery person of goods or services has to go.

Signs to identify certain residences are well known such as realtors advertising homes for sale. These types of signs are more of a permanent nature and remain there until the residence is sold. The signs of the present invention are intended for a Short term duration until the task at hand is accomplished.

### BRIEF SUMMARY OF THE INVENTION

To remedy the above noted problems, the invention discloses outdoor signs that are placed in front of a residence, close to the roadway or street and close to the driveway so that it can easily spotted. The sign will have a special message indicating to the driver that he or she has arrived at the called for destination because most likely no other sign like it will be in the vicinity. In addition it contemplated that lights will be attached to sign that either illuminate the sign and the message thereon or the lights will just be blinking. The frames holding the signs will be similar to the signs used be realtors, yet they will be constructed to easily hold interchangeable signs.

### BRIEF DESCRIPTION OF THE DRAWINGS

FIG. 1 shows a sign display having sign changeable sign display including an illumination;

FIG. 2 shows a sign display allowing for showing differently sized signs;

FIG. 3 shows a different method of affixing a sign to a frame

FIG. 4 shows a hanging sign;

FIG. 5 shows another method of affixing a sign to a frame;

FIG. 6 shows a sign hanging on a door knob;

FIG. 7 shows a sign the is preprinted on a delivery carton

### BRIEF DESCRIPTIONS OF THE INVENTION

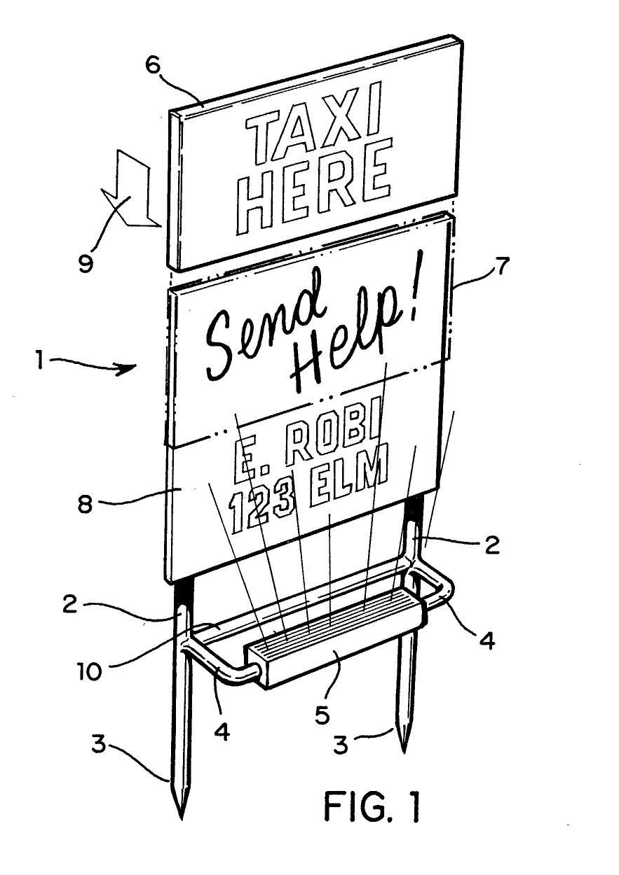

FIG. 1 shows a perspective view of the overall sign 1 which includes the frame or stand 2. The stand 2 can be pushed into the by way of the foot step 10 which pushing into the ground is aided by the sharpened 3 which is well known. The stand has two upstanding posts 2 which may end at a predetermined height. The height of the posts is controlled by the desired height of any of the signs 6-8. The signs or hollow and are open on the bottom so that can be slid down over the posts 2 as is indicated by the arrow 9. Below the sign display there is mounted a forward support 4 which has a battery operated light 5 attached thereon. The light be may turned on for only a short duration of time because the sign will be active for only a short time until the desired goal is obtained.

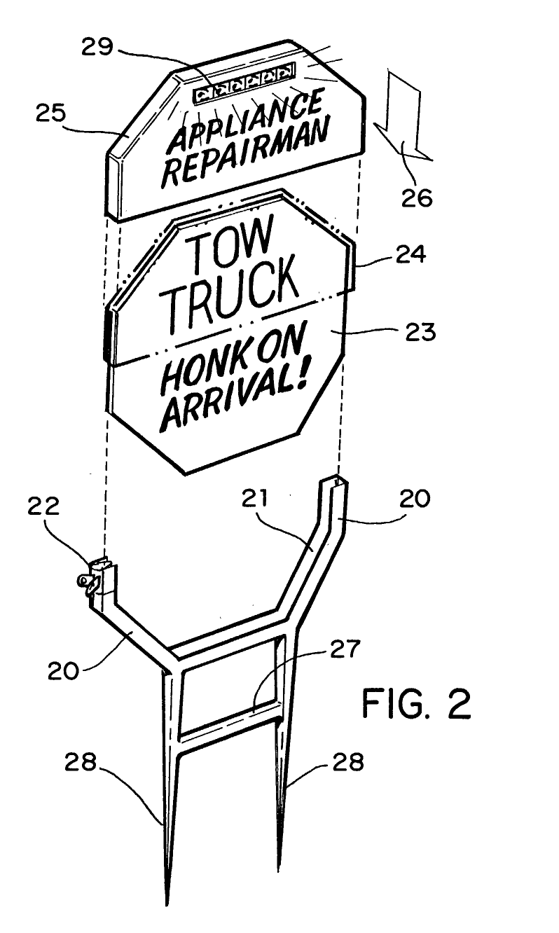

FIG. 2 shows a perspective view of a differently constructed frame and sign display. In this view, the frame is constructed of a U-shaped channel material frame 20 such as a lower half of an octagon. The frame itself is shaped as a U-shaped channel 21. The sign has a shape of an octagon 23 as a base plate whereby the lower section can easily settle into the lower half of the U-shaped frame 20. The upper half of the base plate 23 can receive a hollow and a half of an octagon shaped sign which will easily slip over the upper half of the base plate. Another application is a different and hollow half-shaped octagon sign 26 which can slip over the previous sign 24 or by itself, see arrow 26. In addition to a message, this hollow sign can also can have a flashing lighting system to aid inn attracting a driver's attention. Again, the overall sign can be pushed into the ground by way of the pointed spikes 28 and the foot step 27. The base plate 23 can be held in place by way of a spring clip located I one of the arms of the receptacle 20.

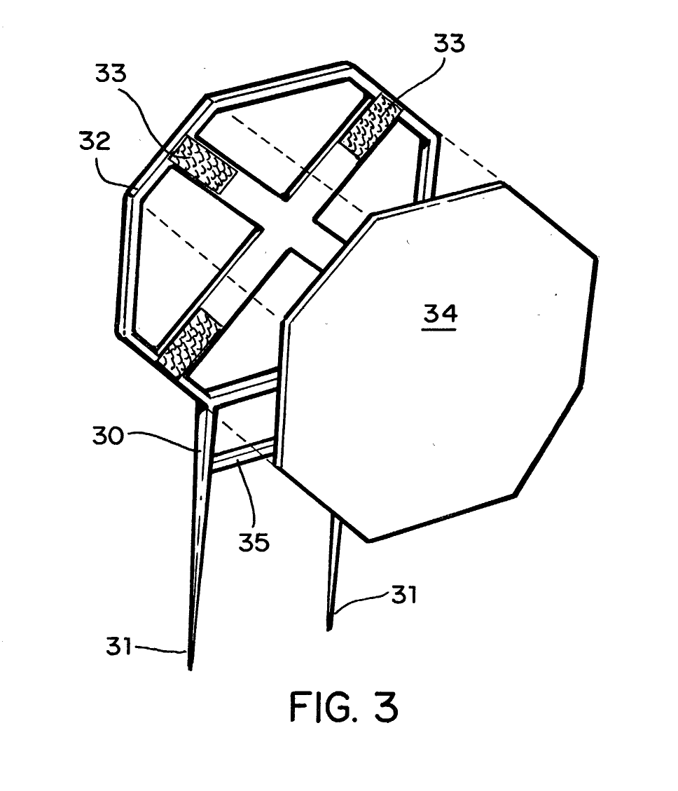

FIG. 3 is a perspective view of another temporary display sign 30 consisting of a frame 32 in an octagon shape. The frame is supported by spikes having sharpened points 31 to be driven into the ground by way of the foot step 35. Patches 33 having hooks thereon are placed on cross arms of the octagon 32. The hook patches are derived from the well known hook and loop fastening system. Therefore, the loops are correspondingly fastened to the back of the blank plate 34 which be removably fastened to the base frame 32. The purpose of the blank plate 34 is that it can be constructed from the school board type material so that personalized messages can be written thereon.

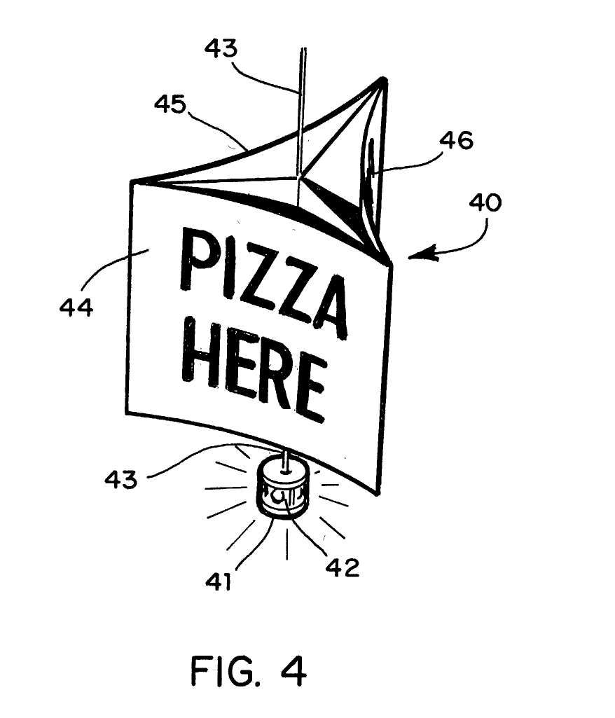

FIG. 4 illustrates a hanging sign. In this illustration there is a hanging rod 43 which may be hung from a porch of a residence or a covered entrance way. The sign 40 itself is of a triangular shape with three exposed sides 44, 45 and 46. The rod 43 continues by having a drum 41 attached below the sign 40. The drum may have blinking light 42 therein to attract attention of the driver of a delivery vehicle. The triangular shape of the sign 40 induces the sign to rotate with the movement of air which makes the sign still more visible or noticeable.

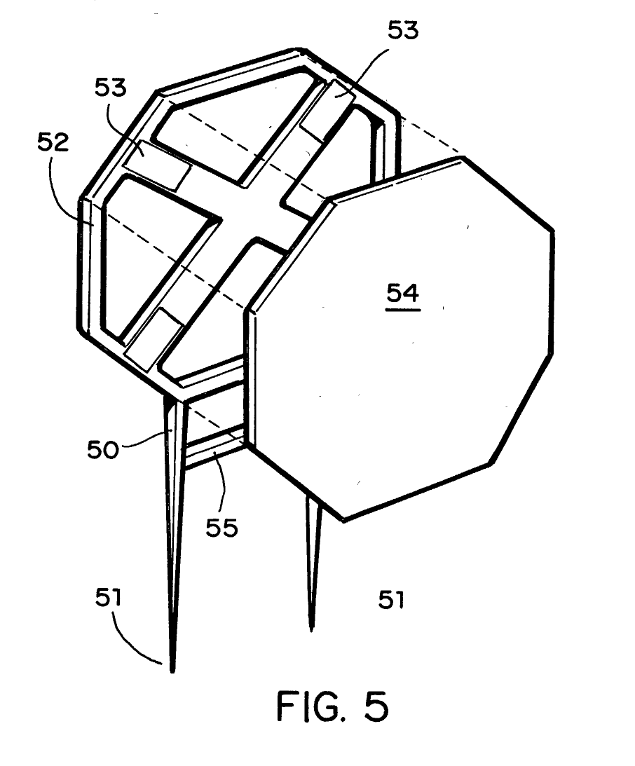

FIG. 5 is a temporary sign similar to FIG. 3 with the difference that instead of hook and loop patches being used they are replaced by magnet patches 53 which are placed on the cross pieces of the octagonically shaped frame 52. The opposite poles of the magnets are fastened to the backside of the plate 54. As was explained with regard to FIG. 3, the spikes of the basic frame 50 are driven into ground by way of the pointed spikes 51 and the foot step 55.

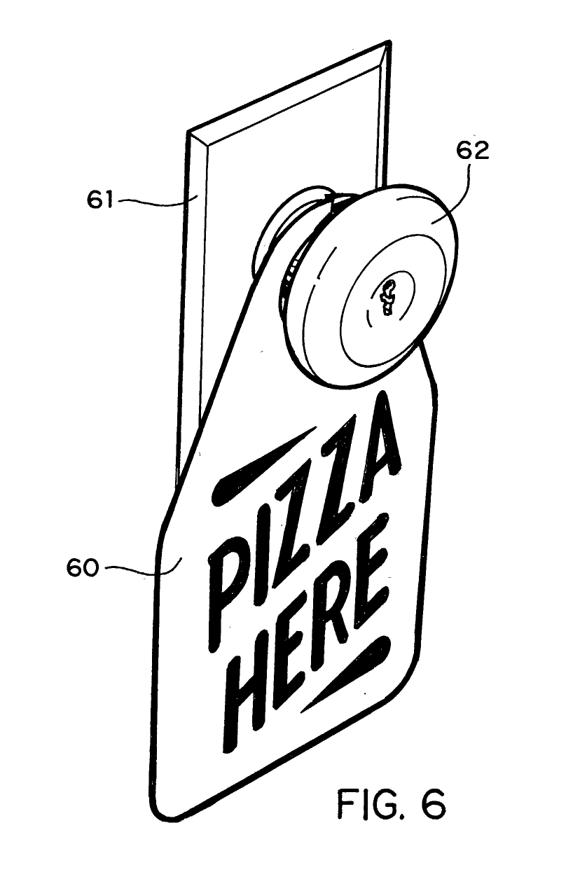

FIG. 6 shows a conventional sign 60 that that are hung on door knobs 62 having a door plate 61. This type of a sign is well known in the hotel or motel industry except that they don't have specialized signs in stock or on hand.

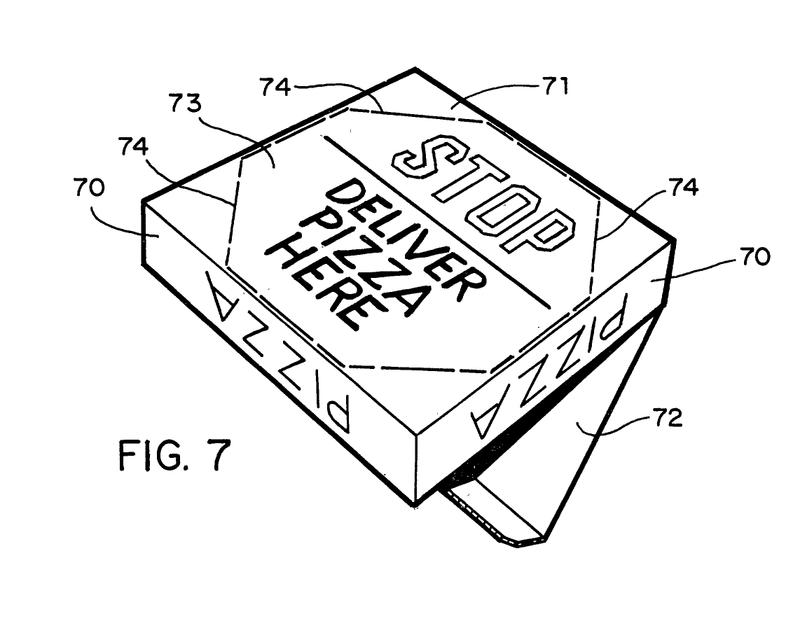

FIG. 7 shows a standard pizza delivery box 70 that typically arrives at a residence after an order has been placed. The main companies that are delivering pizzas could be induced to print the message of this invention on the boxes. The bottom of the box 71 could be printed showing the shape of an octagon with crease or score lines pressed therein. It is merely necessary to remove the botttom 71 from the box, to the triangels back at the score lines 74 and then to place the thus obtained sign over anf of the basic frames of FIGS. 3 and 5.

What is claimed is:

1. A temporary sign adapted to be placed in front of a residence comprising a basic frame, having spikes at the bottom thereof including a foot step, said frame having upstanding posts, a basic rectangular sign having a message at a lower half thereof being attached to said posts, a first hollow rectangular being slid over an upper half of said rectangular sign, being slid over an upper half of said rectangular sign, a further and second hollow rectangular having a message thereon being slid over said first sign.

2. The temporary sign of claim 1 including a light being attached to said posts and below said signs.

3. A temporary sign having a basic U-shaped frame in the shape of a lower half of an octagon adapted to be installed in the ground, a basic sign in the shape of a full octagon having a message printed thereon on its lower half, said basic sign is received in said U-shaped frame, a first hollow sign in a shape of an upper half of an octagon having a message thereon being slipped over an upper half of said basic sign, a second hollow sign having a message thereon being slipped over first sign.

4. The temporary sign of claim 3 including a blinking light attached to said to said temporary sign.

5. The temporary sign of claim 3 including a fastening clip installed between said U-shaped frame and said basic sign.

6. A temporary sign having spikes at a bottom to be driven into the ground, said spikes having at their upper ends a frame in the shape of an octagon, a plate in the same shape as said frame, means for attaching said plate to said frame, said plate at its outer surface is designed so that messages can be written thereon.

7. The temporary sign of claim 6, wherein said means for fastening are hook and loop fasteners.

8. The temporary sign of claim 6, wherein said means for fastening include magnets.

9. The temporary sign of claim 6 including a delivery box having an octagon including a message printed thereon including score lines pressed into the material of said box, corners of said box can be folded backward at the score lines to thereby form a sign that can be installed on said basic frame whereby said bent back corners are located behind said basic frame.
